(19) United States
(12) Patent Application Publication
(10) Pub. No.: US 2013/0265282 A1
(43) Pub. Date: Oct. 10, 2013

(54) TOUCH PANEL AND DISPLAY DEVICE WITH TOUCH PANEL

(71) Applicants: Yousuke Nakagawa, Osaka (JP); Kazuhiro Maeda, Osaka (JP)

(72) Inventors: Yousuke Nakagawa, Osaka (JP); Kazuhiro Maeda, Osaka (JP)

(73) Assignee: Sharp Kabushiki Kaisha, Osaka (JP)

(21) Appl. No.: 13/992,689

(22) PCT Filed: Dec. 1, 2011
(86) PCT No.: PCT/JP2011/077843

§ 371 Date: Jun. 7, 2013

(30) Foreign Application Priority Data
Dec. 8, 2010 (JP) 2010-273975

(51) Int. Cl. G06F 3/044

(52) U.S. Cl. CPC G06F 3/044
USPC 345/174

(57) ABSTRACT

For drive lines (D1 to D5) corresponding to sense lines (S1L to S14L), prescribed pulse signals (P1 to P5) are sequentially applied via terminals (T15 to T19), and for drive lines (D6 to D10) corresponding to sense lines (S1R to S14R), with the same timing as the timing for which the drive lines (D1 to D5) are sequentially driven, the given pulse signals (P1 to P5) are sequentially applied via terminals (T20 to T24).

### TECHNICAL FIELD

The present invention relates to a touch panel and a display device provided with the touch panel. More particularly, the present invention relates to a capacitive type touch panel and a display device provided with the touch panel.

### BACKGROUND ART

In recent years, an increasing number of mobile devices such as PDAs, mobile phones, and laptop computers are equipped with a display panel having a touch panel that the user can control by touching the screen with a finger, a stylus, or the like.

Various types of touch panels are known, which include a capacitive type, a resistive type, an ultrasonic type, an infrared type, and an electromagnetic type. Conventionally, the resistive type touch panels were widely used, but in recent years, a capacitive type touch panel is drawing attention. This is because the capacitive touch panel is capable of multi-touch detection, which is difficult to achieve with the resistive type touch panel.

A cross-matrix structure touch panel is known as a conventional capacitive type touch panel. The structure of such a touch panel is shown in FIG. 16.

As shown in FIG. 16, in the capacitive type touch panel, on a prescribed base substrate, drive lines D1 to D10 made of ten line-shaped electrodes and sense lines S1 to S14 made of fourteen line-shaped electrodes are disposed intersecting with each other while being insulated from each other.

In such a conventional touch panel, as shown in FIG. 16, during the driving operation, prescribed voltage signals P1 to P10 are sequentially applied to all of the drive lines D1 to D10 via terminals T15 to T24.

Also, via terminals T1 to T14 and terminals T25 to T38, all of the sense lines S1 to S14 are connected to a detection circuit.

When a finger of an operator touches the surface of the touch panel, the detection circuit detects a change in capacitance between some of the drive lines D1 to D10 and some of the sense lines S1 to S14. As a result, a touched position is detected.

Currently, such a touch panel has three different types: an external type, an in-cell type, and an on-cell type. Below, with reference to FIG. 17, a configuration of a display device of each type will be explained.

FIG. 17 shows cross-sectional views of configurations of display devices provided with the touch panel of the respective types. FIG. 17(a) is a cross-sectional view showing an example of a configuration of a display device provided with an external touch panel. FIG. 17(b) is a cross-sectional view showing an example of a configuration of a display device provided with an in-cell type touch panel. FIG. 17(c) is a cross-sectional view showing an example of a configuration of a display device provided with an on-cell type touch panel.

As shown in FIG. 17(a), a display panel 100a includes a TFT array substrate 102a, a color filter substrate 103a, and a display element (not shown) sandwiched therebetween. A front polarizing plate 104a is provided on the front side of the color filter substrate 103a, and a rear polarizing plate 101a is provided on the rear side of the TFT array substrate 102a. A touch panel 200a of an external type is provided on the front polarizing plate 104a, and a protective plate 300a is provided thereon.

As shown in FIG. 17(b), a display panel 100b includes a TFT array substrate 102b, a color filter substrate 103b, and a display element (not shown) sandwiched therebetween. A front polarizing plate 104b is provided on the front side of the color filter substrate 103b, and a rear polarizing plate 101b is provided on the rear side of the TFT array substrate 102b. A touch panel 200b of an in-cell type is provided between the TFT array substrate 102b and the color filter substrate 103b in the display panel 100b. A protective plate 300b is provided on the front polarizing plate 104b.

As shown in FIG. 17(c), a display panel 100c includes a TFT array substrate 102c, a color filter substrate 103c, and a display element (not shown) sandwiched therebetween. On the front side of the color filter substrate 103c, a touch panel 200c of an on-cell type is provided, and a front polarizing plate 104c is provided thereon. A protective plate 300c is provided on the front polarizing plate 104c. A rear polarizing plate 101c is provided on the rear side of the TFT array substrate 102c.

In the display device provided with the in-cell type touch panel shown in FIG. 17(b), a transparent electrode for display that is provided in the TFT array substrate or the color filter substrate is patterned. The patterned transparent electrode is also used as both the drive lines and sense lines, and therefore, it is possible to achieve a reduction in thickness.

Patent Document 1 discloses a capacitive touch panel of an in-cell type. FIG. 18 is a diagram showing an electrode pattern of the touch panel disclosed in Patent Document 1.

In the display device of Patent Document 1, as shown in FIG. 18, by patterning a common electrode, the common electrode is also used as drive lines D1 to D6 and sense lines S1 to S10 of the capacitive touch panel, thereby realizing a touch panel functionality.

As shown in FIG. 18, the common electrode includes the sense lines S1 to S10 made of ten line-shaped electrodes. Also, the drive lines D1 to D6 constituted of planar electrodes arranged regularly and separated from each other are patterned so as to operably couple with the respective sense lines.

Upon driving, prescribed voltage signals are sequentially applied to the drive lines D1 to D6 operatively couple with the respective sense lines S1 to S10.

FIG. 19 is a waveform diagram showing voltage signals Vout1 to Vout10 outputted by the detection circuit connected to the sense lines S1 to S10 and voltage signals P1 to P6 applied to the drive lines D1 to D6 in the touch panel of FIG. 18.

As shown in FIG. 19, upon driving, prescribed pulse (voltage) signals P1 to P6 are sequentially applied to the drive lines D1 to D6.

In response, the output signals Vout1 to Vout10 are outputted from the detection circuit (such as a circuit shown in FIG. 3 below) connected to the sense lines S1 to S10.

FIG. 20 is a diagram for illustrating a detection of a touched position in the touch panel shown in FIG. 18.

As shown in FIG. 20, when a finger of the operator touches a panel surface, the detection circuit detects a change in capacitance between one of the drive lines D1 to D6 and one of the sense lines S1 to S10, thereby detecting the touched position.

Known examples of the operation mode of liquid crystal molecules in a liquid crystal display device include a TN (twisted nematic) mode, an STN (super twisted nematic) mode, a VA (vertical aligned) mode, an ECB (electrically controlled birefringence) mode, and an IPS (in-plane switching) mode, for example.

### RELATED ART DOCUMENTS

### Patent Documents

Patent Document 1 US Patent Application Laid-Open Publication No. 2010/0001973 (published on Jan. 7, 2010)
Patent Document 2: Japanese Patent Application Laid-Open Publication No. 2009-230276 (published on Oct. 8, 2009)

### SUMMARY OF THE INVENTION

### Problems to be Solved by the Invention

However, the conventional technology described above has a problem of requiring a long sensing time because all of the drive lines D1 to Dm (m is an integer of 2 or greater) are sequentially driven by being applied with prescribed pulses. This problem becomes more significant as the number of drive lines increases.

In particular, in the touch panel of an in-cell type as described in Patent Document 1, in order to eliminate an effect on the display, it is necessary to conduct sensing during a blanking period, which makes it difficult to secure a sufficient sensing time, and as a result, the sensitivity to an object becomes lower.

The present invention was made in view of the above-mentioned problem, and an object thereof is to provide a touch panel that can detect an object accurately and quickly, and a display device provided with the touch panel.

### Means for Solving the Problems

In order to solve the above-mentioned problem, a touch panel of the present invention includes:
(1) first electrodes having respective conductive paths extending along a first direction; and
(2) plural groups of second electrodes, each of the plural groups of second electrodes including at least one second electrode having a conductive path extending along a second direction,
(3) wherein a position touched by an object is detected by sensing a change in capacitance between at least one first electrode of the first electrode group and at least one second electrode belonging to at least one of the plural groups of second electrodes,
(4) wherein, among the plural groups of second electrodes, respective conductive paths of second electrodes belonging to different groups are electrically isolated from each other, and
(5) wherein, except for some of the first electrodes that correspond to at least two of the plurality of groups of second electrodes, the first electrodes belonging to each group that corresponds only to one of the plurality of groups of second electrodes are driven line-sequentially at the same time, or driven line-sequentially at such a timing that respective driving periods overlap each other.

With this configuration, second electrodes (sense lines S, for example) are divided into a plurality of groups such as a first group of second electrodes, a second group of second electrodes, and a third group of second electrodes. The conductive paths of the respective second electrodes belonging to the first group of second electrodes, the second group of second electrodes, and the like extend along the second direction (X direction, for example) in each group. However, between different groups of second electrodes, the conductive paths of the second electrodes are not connected to each other, and are electrically insulated.

Each group of second electrodes corresponds to some of the first electrodes (drive lines D, for example). “Corresponds” means that the second electrode group and the first electrodes have a relation in which a position touched by an object is identified by detecting a change in capacitance therebetween.

The first electrodes may include a first electrode group that is common between (or corresponds to) a plurality of groups of second electrodes. Except for the first electrode group that is commonly used, the respective first electrodes belonging to each group that corresponds only to one of the plurality of groups of second electrodes are driven in a line-sequential manner at the same timing as each other, or at a timing that is set such that respective driving periods overlap each other.

As a result, the driving time can be reduced as compared with the configuration in which all of the first electrodes are driven in a line-sequential manner, and therefore, it is possible to reduce the sensing time.

Thus, in a touch panel that detects a touched position by utilizing the charge transfer scheme, the frequency of charge transfer can be increased, thereby making it possible to increase a difference in output voltage between when the screen is touched and when the screen in not touched. This makes it possible to determine whether the screen is touched or not accurately.

As a result, a touch panel that can detect an object accurately and quickly can be achieved.

In a display device provided with a touch panel of the in-cell type, the sensing operation can only be conducted during the vertical blanking period in order to eliminate an effect on the display, and therefore, the sensing time is limited. Because the touch panel of the present invention can reduce the sensing time as described above, the present invention can be suitably used for not only the external type and the on-cell type, but also a touch panel of the in-cell type.

### EFFECTS OF THE INVENTION

A touch panel of the present invention includes:
a group of first electrodes as a plurality of first electrodes extending along a first direction, forming conductive paths along the first direction; and
a plurality of groups of second electrodes, each of the plurality of groups of second electrodes including at least one second electrode extending along a second direction, forming a conductive path along a second direction,
wherein a position touched by an object is detected by sensing a change in capacitance between at least one first electrode of the group of first electrodes and at least one second electrode belonging to at least one of the plurality of groups of second electrodes,
wherein, among the plurality of groups of second electrodes, respective conductive paths of second electrodes belonging to different groups are electrically isolated from each other, and
wherein, except for some of the first electrodes that correspond to at least two of the plurality of groups of second electrodes, the respective first electrodes belonging to each group that corresponds only to one of the plurality of groups of second electrodes are driven in a line-sequential manner at the same timing as each other, or at a timing that is set such that respective driving periods overlap each other.

The display device of the present invention includes the above-mentioned touch panel.

Therefore, it is possible to achieve a touch panel that can detect an object accurately and quickly, and a display device provided with the touch panel.

### BRIEF DESCRIPTION OF THE DRAWINGS

FIG. 1 is a diagram showing an electrode pattern of a touch panel according to Embodiment 1 of the present invention.

FIG. 2 shows waveform diagrams for comparing voltage signals applied to drive lines of a conventional touch panel with voltage signals applied to drive lines of a touch panel of Embodiment 1 of the present invention. FIG. 2(a) shows voltage signals applied to drive lines of a conventional touch panel, and FIG. 2(b) shows voltage signals applied to drive lines of the touch panel of Embodiment 1 of the present invention.

FIG. 3 is a circuit diagram showing a configuration of a detection circuit provided in a touch panel of Embodiment 1 of the present invention.

FIG. 4 is a diagram showing a relation between a charge transfer frequency N and a difference ΔVout in output voltages of an integral circuit between when the touch panel is not touched by a finger of an operator (non-touch) and when the touch panel is touched (touch) in the detection circuit provided in the touch panel of Embodiment 1 of the present invention.

FIG. 5 is a diagram showing an electrode pattern of a touch panel according to Embodiment 2 of the present invention.

FIG. 6 is an enlarged schematic diagram showing an electrode pattern of the touch panel of Embodiment 2 of the present invention.

FIG. 7 shows diagrams illustrating display states of a display device provided with a touch panel. FIG. 7(a) shows a display state of the display device when dividing points of sense lines coincide with each other, and FIG. 7(b) shows a display state of the display device when dividing points of sense lines vary as in Embodiment 2 of the present invention.

FIG. 8 is a diagram showing an electrode pattern of a touch panel according to Embodiment 3 of the present invention.

FIG. 9 is an enlarged schematic diagram showing an electrode pattern of a touch panel of Embodiment 3 of the present invention.

FIG. 10 is a diagram showing an electrode pattern of a touch panel according to Embodiment 4 of the present invention.

FIG. 11 is a diagram showing an electrode pattern of a touch panel according to Embodiment 5 of the present invention.

FIG. 12 is a cross-sectional view showing a configuration of a liquid crystal display device according to Example 1 of the present invention.

FIG. 13 is a diagram showing an electrode pattern of a touch panel in the liquid crystal display device of Example 1 of the present invention.

FIG. 14 is a waveform diagram showing voltage signals outputted from a detection circuit connected to sense lines of a touch panel and voltage signals applied to drive lines in the liquid crystal display device of Example 1 of the present invention.

FIG. 15 is a cross-sectional view showing a configuration of a liquid crystal display device according to Example 2 of the present invention.

FIG. 16 is a diagram showing a configuration of a conventional capacitive type touch panel.

FIG. 17 shows cross-sectional views each illustrating a configuration of a display device equipped with a touch panels of each type. FIG. 17(a) shows an example of a configuration of a display device provided with an external type touch panel, FIG. 17(b) shows an example of a configuration of a display device provided with an in-cell type touch panel, and FIG. 17(c) shows an example of a configuration of a display device provided with an on-cell type touch panel.

FIG. 18 is a diagram showing an electrode pattern of the touch panel disclosed in Patent Document 1.

FIG. 19 is a waveform diagram showing voltage signals outputted from a detection circuit connected to sense lines and voltage signals applied to drive lines in the touch panel disclosed in Patent Document 1.

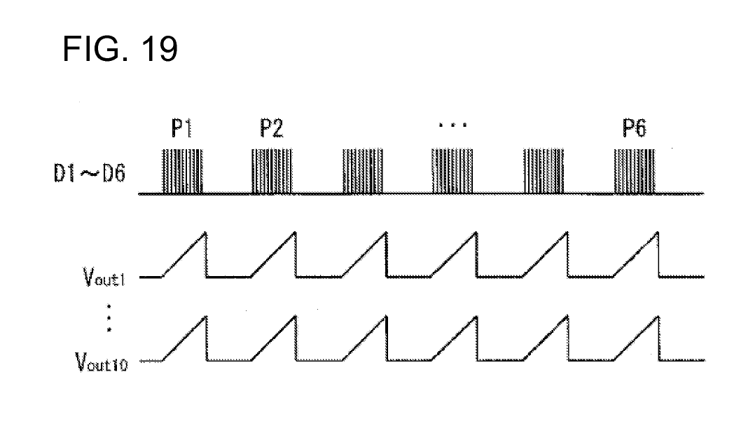

FIG. 20 is a diagram illustrating a detection of a touched position in the touch panel disclosed in Patent Document 1.

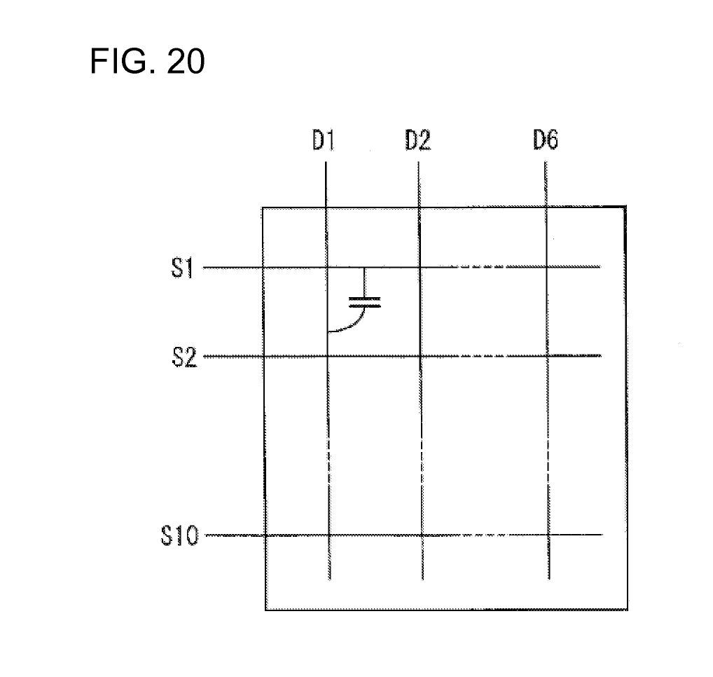

FIG. 21 is a diagram showing an ON/OFF state of a switch SW1 and a switch SW2 in the detection circuit shown in FIG. 3.

FIG. 22 is a diagram showing an electrode pattern of a touch panel according to Embodiment 6 of the present invention.

### DETAILED DESCRIPTION OF EMBODIMENTS

Below, embodiments of the present invention will be explained in detail. The quantities, dimensions, materials, shapes, positional relations, and the like of constituting components described in the respective embodiments below are merely illustrative examples, and the present invention is not limited thereto, unless otherwise specified.

### Embodiment 1

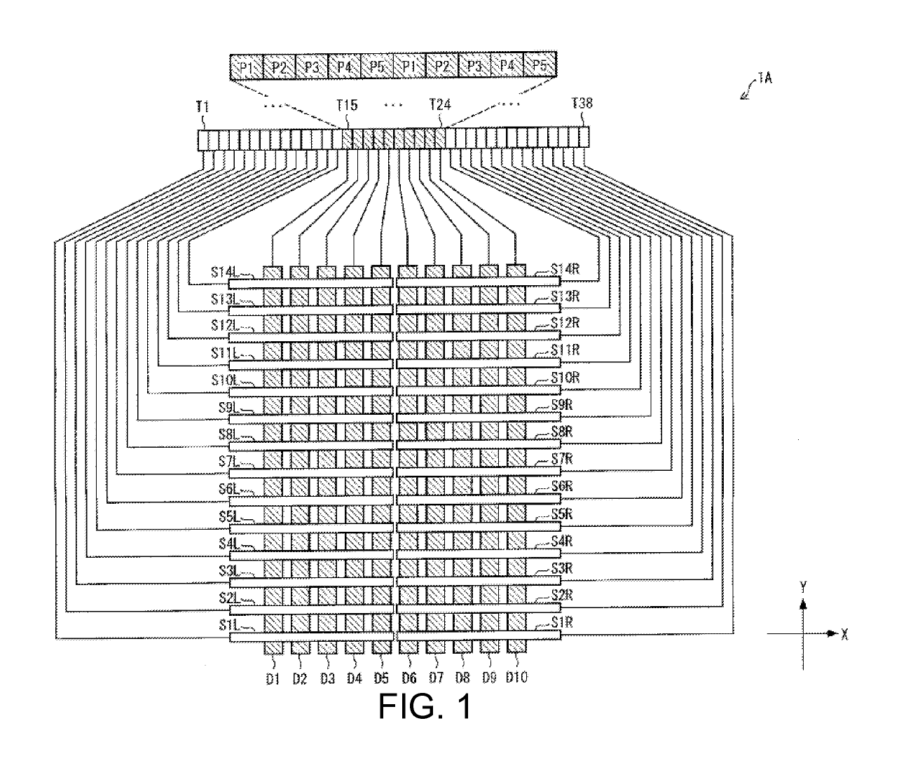

Below, Embodiment 1 of the present invention will be explained in detail with reference to FIGS. 1 to 4.

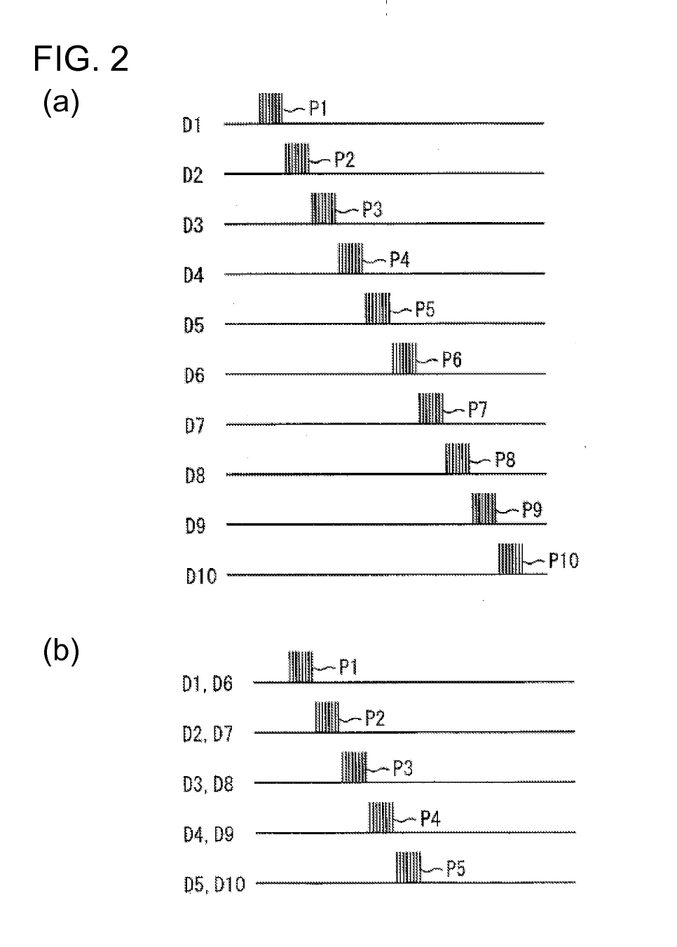

First, with reference to FIGS. 1 and 2, a capacitive type touch panel according to the present embodiment will be explained.

(Electrode Configuration of Touch Panel)

FIG. 1 is a diagram showing an electrode pattern of a touch panel of the present embodiment.

As shown in FIG. 1, in a touch panel 1A of the present embodiment, drive lines D1 to D10 (group of first electrodes) made of ten line-shaped electrodes (first electrodes, conductive paths) are disposed in parallel with each other along a Y direction (first direction) at even intervals.

Sense lines S1L to S14L (first group of second electrodes) made of fourteen line-shaped electrodes (second electrodes, conductive path) are disposed in parallel with each other along an X direction (second direction) at even intervals so as to intersect with the drive lines D1 to D5. Sense lines S1R to S14R (second group of second electrodes) made of fourteen line-shaped electrodes (second electrodes) are disposed in parallel with each other along the X direction at even intervals so as to intersect with the drive lines D6 to D10.

The sense lines S1L to S14L and the corresponding sense lines S1R to S14R are symmetrical with respect to the axis along the Y direction. That is, the sense lines of the present embodiment are constituted of two groups of sense lines, which are sense lines S1L to S14L and sense lines S1R to S14R.

The drive lines D1 to D5 correspond to the sense lines S1L to S14L, and the drive lines D6 to D10 correspond to the sense lines S1R to S14R.

The drive lines D1 to D5 corresponding only to the sense lines S1L to S14L, and the drive lines D6 to D10 corresponding only to the sense lines S1R to S14R are driven at the same timing in a line-sequential manner. In the present embodiment, the drive lines D1 to D5 are sequentially applied with prescribed pulse (voltage) signals P1 to P5 via terminals T15 to T19, and at the same timing, the drive lines D6 to D10 are sequentially applied with prescribed pulse (voltage) signals P1 to P5 via terminals T20 to T24.

The sense lines S1L to S14L are connected to detection circuits, which will be described later, via the terminals T1 to T14, and the sense lines S1R to S14R are connected to detection circuits, which will be described later, via the terminals T25 to T38.

When a finger of the operator (object) touches the touch panel 1A, the touched position is detected by the detection circuit that detects at least one of a change in capacitance between at least one drive line out of the drive lines D1 to D5 and at least one sense line out of the sense lines S1L to S14L, and a change in capacitance between at least one drive line out of the drive lines D6 to D10 and at least one sense line out of the sense lines S1R to S14R.

(Line-Sequential Driving)

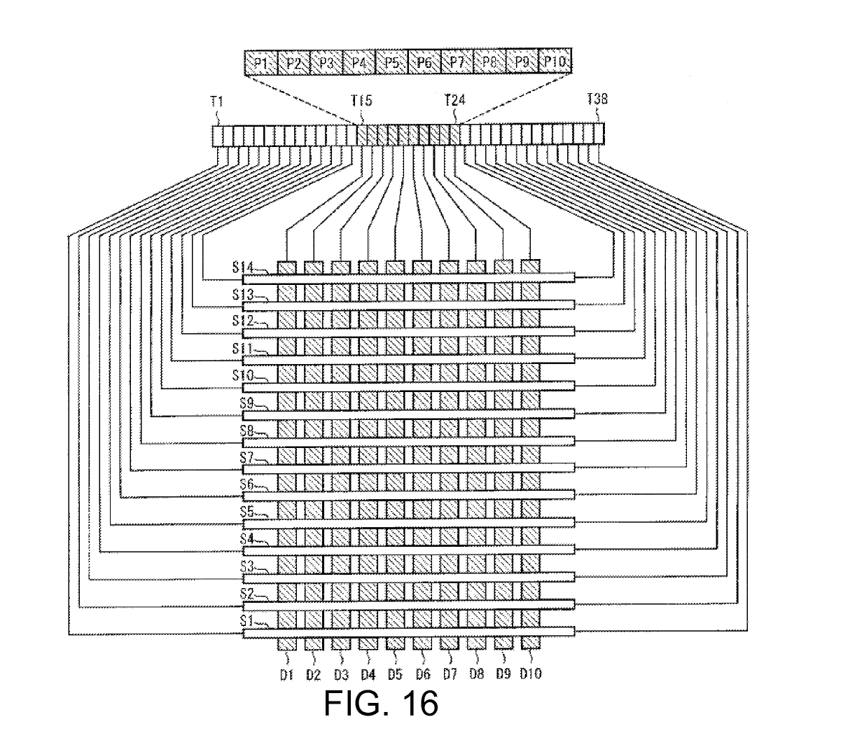

FIG. 2 shows waveform diagrams for comparing voltage signals applied to drive lines D1 to D10 between a conventional touch panel and the touch panel of the present embodiment. FIG. 2(a) shows voltage signals applied to the drive lines D1 to D10 of the conventional touch panel shown in FIG. 16, and FIG. 2(b) shows voltage signals applied to the drive lines D1 to D10 of the touch panel of the present embodiment shown in FIG. 1.

As shown in FIG. 2, in the conventional touch panel, prescribed voltage signals P1 to P10 are sequentially applied to all of the drive lines D1 to D10 for driving.

On the other hand, in the touch panel of the present embodiment, the sense lines S1 to S14 shown in FIG. 16 are divided into the sense lines S1L to S14L and the sense lines S1R to S14R, and therefore, it is possible to apply prescribed voltage signals P1 to P5 sequentially to the drive lines D1 to D5 corresponding to the sense lines S1L to S14L and to the drive lines D6 to D10 corresponding to the sense lines S1R to S14R at the same timing.

“At the same timing” specifically means that voltage signals P1 having the same driving period are each applied to the drive line D1 and the drive line D6, which are respectively the first drive lines of the first group of second electrodes and of the second group of second electrodes at the same time, and thereafter, voltage signals are applied to two drive lines at a time, sequentially from the second drive lines D2 and D7 to the last drive lines D5 and D10 in the respective groups.

Therefore, the driving frequency of the drive lines D1 to D10 can be reduced by half, which is an inverse number of two, i.e., the number of groups. Thus, the time required for sensing can be reduced by half.

In the present embodiment, the prescribed voltage signals P1 to P5 are sequentially applied to the drive lines D1 to D5 and to the drive lines D6 to D10 at the same timing, but the present invention is not limited to such as long as the timing at which the voltage signals are sequentially applied is set such that at least some of the driving periods overlap each other.

Specifically, “the timing is set such that driving periods overlap each other” means that voltage signals P1 and P6 are applied to the respective first drive line D1 and D6 such that the driving periods overlap each other, and thereafter, voltage signals are applied to two drive lines at a time sequentially from the second drive lines D2 and D7 to the last drive lines D5 and D10 in the respective groups such that the driving periods partially overlap each other.

In this way, the time required for sensing can be reduced.

When the “drive lines that are driven line-sequentially at the same timing or at a timing that is set such that respective driving periods overlap each other” are referred to as the “drive lines having overlapping driving periods,” the drive lines D1 and D6, for example, are the “drive lines that have overlapping driving periods.”

(Configuration of Detection Circuit)

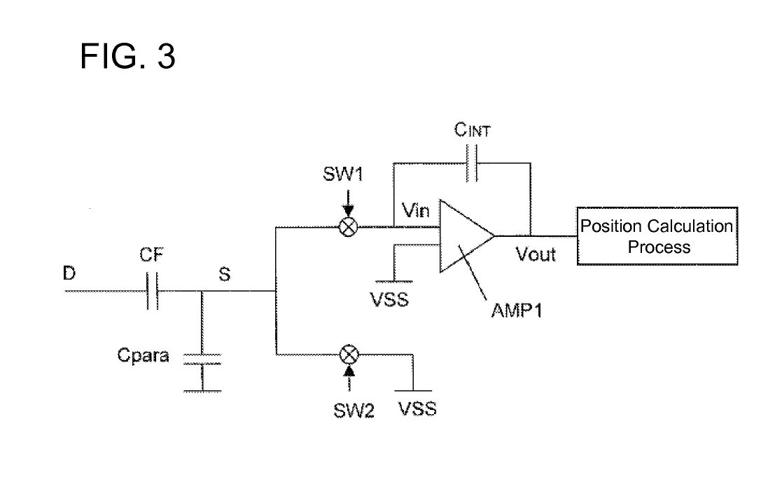

Below, with reference to FIG. 3, the detection circuit for detecting a position touched by an operator will be explained. FIG. 3 is a circuit diagram showing a configuration of the detection circuit provided in the touch panel of the present embodiment.

As shown in FIG. 3, a drive line D made of one line-shaped electrode, and a sense line S made of one line-shaped electrode are disposed intersecting with each other while being electrically insulated from each other.

When voltage signals are applied to the drive line D and the sense line S, if a finger of the operator touches a point near the intersection region of the drive line D and the sense line S, the size (capacitance) of the capacitance CF between the drive line D and the sense line S changes. By detecting the change in capacitance, it can be determined whether the screen is touched or not.

Specifically, the sense line S is electrically connected via a switch SW1 to an integral circuit constituted of an amplifier AMP1 and an integral capacitance CINT, and is connected to a reference voltage VSS via a switch SW2. By fixing an input voltage Vin of the amplifier AMP1 to the reference voltage VSS, and by conducting a charge transfer between the capacitance CF and the integral capacitance CINT, a change in capacitance in the capacitance CF is detected.

In the display device provided with an in-cell type touch panel, for example, the sensing operation can be conducted only during the vertical blanking period. Therefore, only during the vertical blanking period, the switch SW1 and the switch SW2 are sequentially turned on to conduct a charge transfer between the capacitance CF and the integral capacitance CINT, and a change in capacitance in the capacitance CF is detected.

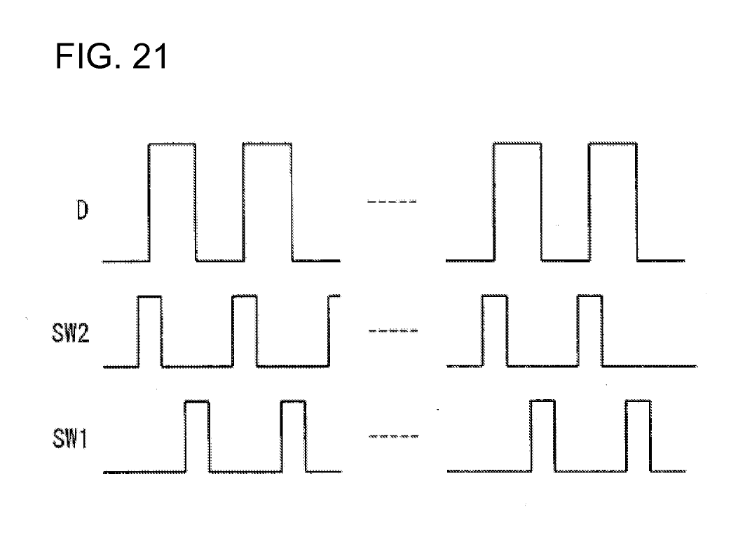

FIG. 21 is a diagram showing an ON/OFF state of the switch SW1 and the switch SW2. As shown in FIG. 21, first, the switch SW2 is turned on, thereby fixing the sense line S to a certain potential (the reference voltage VSS). Thereafter, the switch SW2 is turned off, and the switch SW1 is turned on, thereby conducting a charge transfer between the capacitance CF and the integral capacitance CINT. In this manner, by repeatedly turning on and off the switch SW1 and the switch SW2, the charges are transferred to the integral capacitance CINT. This causes the amplifier AMP1 to output an output voltage Vout corresponding to the integral value of the charges transferred to the integral capacitance CINT.

(Detection Operation for Touch/Non-touch)

The charges Q1 accumulated in the integral capacitance CINT when the finger of the operator is not touching the touch panel and the charges Q2 accumulated in the integral capacitance CINT when the touch panel is touched can be represented by the following formulae (1) and (2), where Cf1 is a capacitance at the capacitance CF when the finger of the operator is not touching the touch panel, and Cf2 is a capacitance at the capacitance CF when the touch panel is touched:

Q1=Cf1×ΔVd×N (1),

Q2=Cf2×ΔVd×N (2).

Here, ΔVd is an amplitude of a voltage signal applied to the drive line D, and N is a charge transfer frequency.

Therefore, the output voltage Vout1 of the integral circuit when the finger of the operator is not touching the touch panel, and the output voltage Vout2 of the integral circuit when the touch panel is touched can be represented by the following formulae (3) and (4):

Vout1=Q1/Cint=Cf1×ΔVd×N/Cint (3),

Vout2=Q2/Cint=Cf2×ΔVd×N/Cint (4).

Here, Cint is the capacitance at the integral capacitance CINT.

A difference ΔQ between the charges Q1 accumulated in the integral capacitance CINT when the finger of the operator is not touching the touch panel and the charges Q2 accumulated in the integral capacitance CINT when the touch panel is touched can be represented by the following formula (5), where ACf is a difference between the capacitance Cf1 of the capacitance CF when the finger of the operator is not touching the touch panel and the capacitance Cf2 of the capacitance CF when the touch panel is touched:

ΔAQ=ΔCf×ΔVd×N (5).

Therefore, a difference ΔVout between the output voltage Vout1 of the integral circuit when the finger of the operator is not touching the touch panel, and the output voltage Vout2 of the integral circuit when the touch panel is touched can be represented by the following formula (6):

ΔVout=ΔQ/Cint=(ΔC×ΔVd×N)/Cint (6).

As shown in the formula (6), the difference in output voltages of the integral circuit between when the touch panel is not touched by the finger of the operator and when the touch panel is touched increases as the charge transfer frequency N increases.

The touched position is calculated based on the output voltage Vout1 and Vout2 of the integral circuit. That is, the detection circuit determines a combination of a drive line D and a sense line S where the output voltage difference ΔVout exceeds a threshold value, thereby detecting a position touched by the finger.

With the charge transfer scheme shown in FIG. 3, the effect of the parasitic capacitance Cpara of the sense line S can be eliminated.

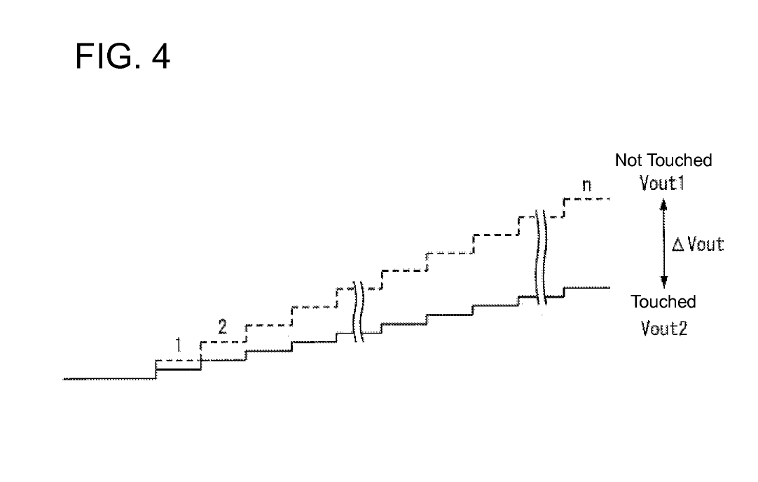

FIG. 4 is a diagram showing a relation between the charge transfer frequency N and the difference ΔVout in output voltages of an integral circuit between when the touch panel is not touched by a finger of the operator (non-touch) and when the touch panel is touched (touch).

As shown in FIG. 4, the difference ΔVout between the output voltage Vout1 of the integral circuit when the touch panel is not touched by the finger of the operator and the output voltage Vout2 of the integral circuit when the touch panel is touched increases as the charge transfer frequency N increases.

Thus, by increasing the charge transfer frequency N, it is possible to accurately determine whether or not the screen is touched.

In the display device provided with an in-cell type touch panel having the conventional configuration, for example, because the sensing operation can only be conducted during the vertical blanking period, the charge transfer frequency N was limited, and a sufficient output voltage difference ΔVout could not be obtained, which did not allow the touch and non-touch to be determined accurately.

However, with the configuration of the touch panel of the present embodiment, it is possible to reduce the time required for sensing by half. This makes it possible to increase the charge transfer frequency N, and as a result, the output voltage difference ΔVout can be increased. Thus, it becomes possible to accurately determine whether the screen is touched or not.

### Embodiment 2

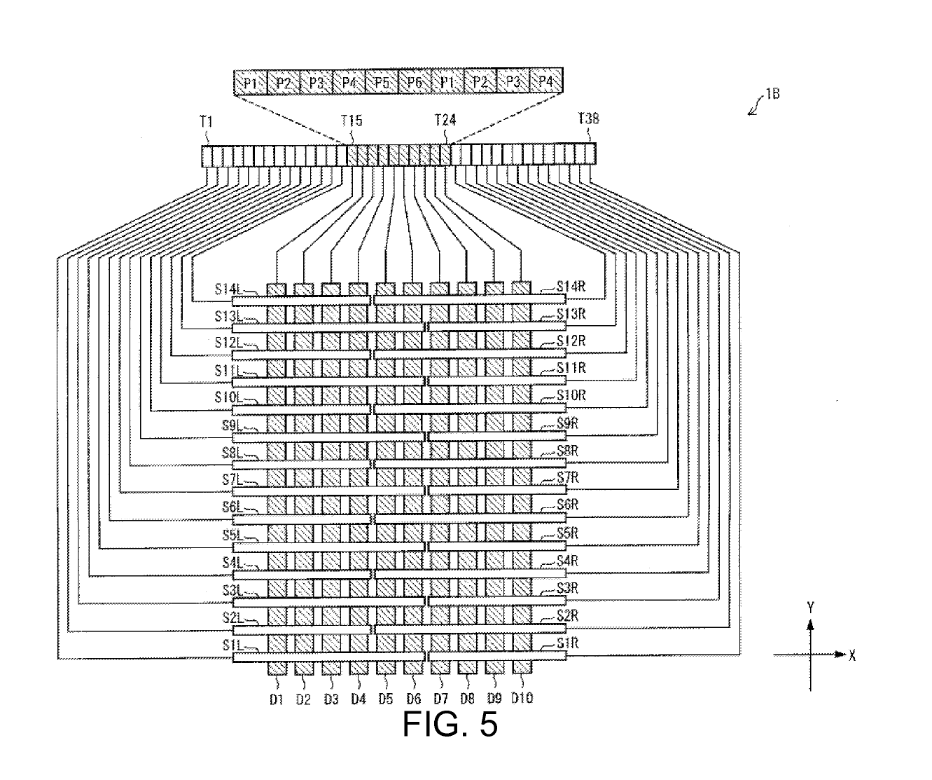

Embodiment 2 of the capacitive touch panel of the present invention will be explained below with reference to FIGS. 5 to 7.

For ease of explanation, the components having the same functions as those in the drawings described in Embodiment 1 above are given the same reference characters, and the descriptions thereof are omitted.

(Electrode Configuration of Touch Panel)

FIG. 5 is a diagram showing an electrode pattern of a touch panel of the present embodiment.

As shown in FIG. 5, in a touch panel 1B, drive lines D1 to D10 (first electrode groups) made of ten line-shaped electrodes (first electrodes) are disposed in parallel with each other at even intervals along Y direction.

Among sense lines S1L to S14L (first group of second electrodes) made of fourteen line-shaped electrodes (second electrodes), odd-numbered sense lines S1L, S3L, . . . , S13L are disposed in parallel with each other at even intervals along the X direction so as to intersect with the drive lines D1 to D6. Among the sense lines S1L to S14L made of fourteen line-shaped electrodes, even-numbered sense lines S2L, S4L . . . S14L are disposed in parallel with each other at even intervals along the X direction so as to intersect with the drive lines D1 to D4. That is, the lengths of the sense lines S1L to S14L vary.

On the other hand, among sense lines S1R to S14R (second group of second electrodes) made of fourteen line-shaped electrodes (second electrodes), odd-numbered sense lines S1R, S3R, . . . , S13R are disposed in parallel with each other at even intervals along the X direction so as to intersect with the drive lines D1 to D4. Among the sense lines S1R to S14R made of fourteen line-shaped electrodes, even-numbered sense lines S2R, S4R . . . S14R are disposed in parallel with each other at even intervals along the X direction so as to intersect with the drive lines D1 to D6. That is, the lengths of the sense lines S1R to S14R vary.

The lengths of the sense lines S1L to S14L and the sense lines S1R to S14R may change periodically or irregularly as long as a plurality of first electrode groups that can be driven at the same timing line-sequentially can be configured.

The drive lines D1 to D4 operably couple with only the sense lines S1L to S14L, and the drive lines D7 to D10 operably couple with only the sense lines S1R to S14R. The drive lines D5 and D6 operably couple with both the odd-numbered sense lines among the sense lines S1L to S14L and the even-numbered sense lines among the sense line S1R to S14R.

Except for the drive lines D5 and D6 that both operably couple with some of the sense lines S1L to S14L and some of the sense lines S1R to S14R, the drive lines D1 to D4 that operably couple with only the sense lines S1L to S14L, and the drive lines D7 to D10 that operably couple with only the sense lines S1R to S14R are driven at the same timing line-sequentially. In the present embodiment, prescribed pulse (voltage) signals P1 to P6 are sequentially applied to the drive lines D1 to D6 via terminals T15 to T20, and prescribed pulse (voltage) signals P1 to P4 are sequentially applied to the drive lines D7 to D10 via the terminals T21 to T24 at the same timing as the drive lines D1 to D4.

The drive lines D5 and D6 that are commonly used by the two groups of second electrodes can be driven line-sequentially after driving the two groups of second electrodes line-sequentially, that is, after applying the pulse signals P1 to P4, or before driving the two groups of second electrodes line-sequentially.

The sense lines S1L to S14L are connected to the detection circuit shown in FIG. 3 via the terminals T1 to T14, and the sense lines S1R to S14R are connected to the detection circuit shown in FIG. 3 via the terminals T25 to T38.

When the finger of the operator touches the touch panel 1B, the touched position is detected by the detection circuit shown in FIG. 3 that detects a change in capacitance between at least one drive line out of the drive lines D1 to D10 and at least one sense line out of the sense lines S1R to S14R and S1L to S14L.

In the touch panel 1B of the present embodiment, the sense lines S1 to S14 in the conventional configuration shown in FIG. 16 are divided into the sense lines S1L to S14L and the sense lines S1R to S14R, and the dividing points (dividing position) between the sense lines S1L to S14L and the sense lines S1R to S14R in the X direction vary among the respective rows, or in other words, among the respective sense lines.

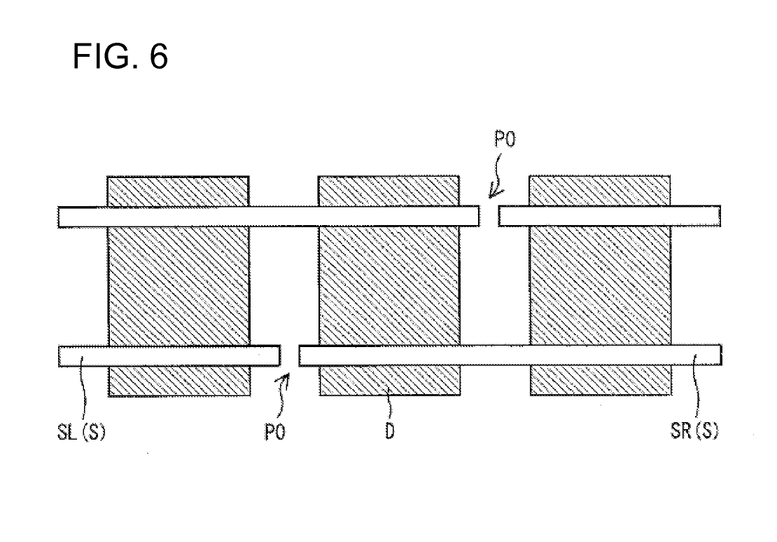

FIG. 6 is an enlarged schematic diagram showing an electrode pattern of the touch panel of the present embodiment.

As shown in FIG. 6, in the touch panel of the present embodiment, the sense lines S are divided such that the lengths of the sense lines SL and the sense lines SR differ between the respective rows. That is, the dividing point PO at which a sense line SL and a sense line SR are electrically insulated from each other in the X direction does not coincide with each other, but varies in each row of the sense lines.

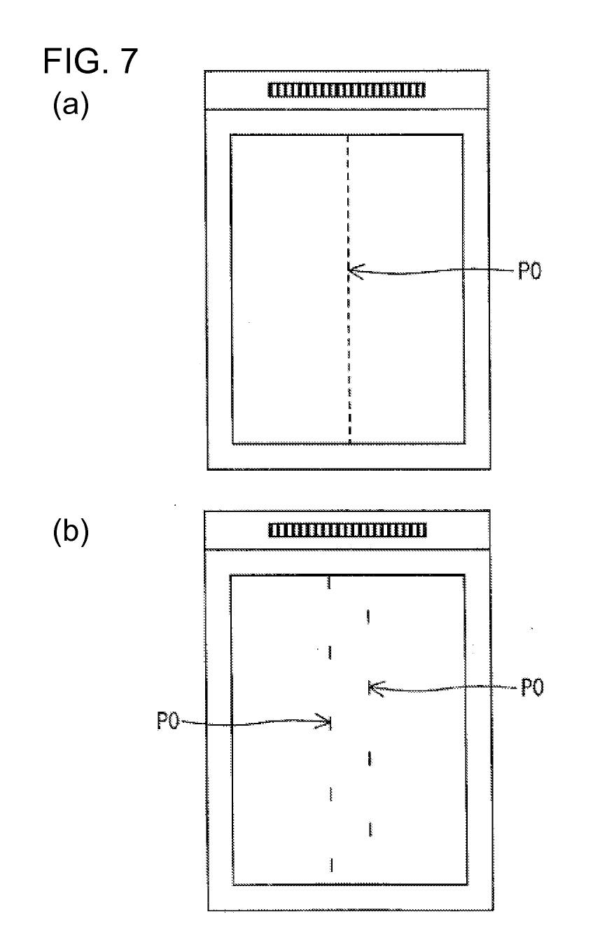

FIG. 7 shows diagrams illustrating display states of the display device equipped with such a touch panel. FIG. 7(a) shows a display state of the display device when the dividing points coincide with each other among the sense lines S, and FIG. 7(b) shows a display state of the display device when the dividing points do not coincide among the sense lines S as in the present embodiment.

When the dividing points coincide among the sense lines S, as shown in FIG. 7(a), on the display screen, the respective dividing points of the sense lines S form a line, which is easily noticeable.

On the other hand, when the dividing points do not coincide among the sense lines S as in the present embodiment, as shown in FIG. 7(b), on the display screen, the respective dividing points of the sense lines S do not form a clear line, which makes them less noticeable.

In the present embodiment, prescribed pulse (voltage) signals P1 to P6 are sequentially applied to the drive lines D1 to D6, and prescribed pulse (voltage) signals P1 to P4 are sequentially applied to the drive lines D7 to D10 at the same timing as the drive lines D1 to D4. As a result, as compared to the case in which the respective drive lines D1 to D10 are sequentially applied with prescribed pulse (voltage) signals P1 to P10, the time required for sensing can be reduced.

As a result, the charge transfer frequency N can be increased as in Embodiment 1 above, which allows the output voltage difference ΔVout to be larger. Therefore, it is possible to accurately determine whether the screen is touched or not.

### Embodiment 3

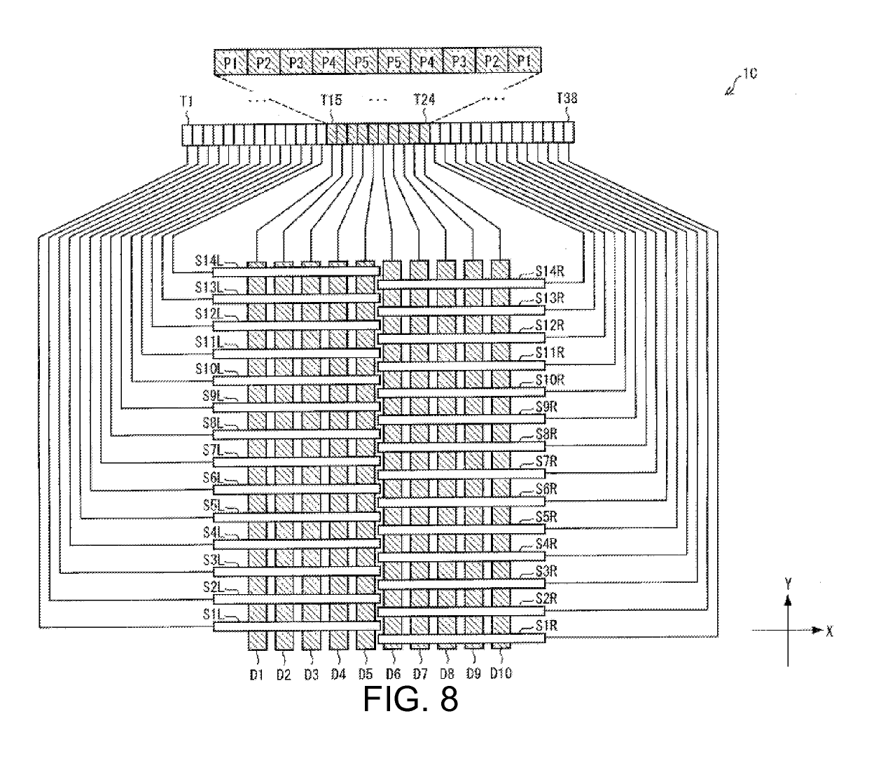

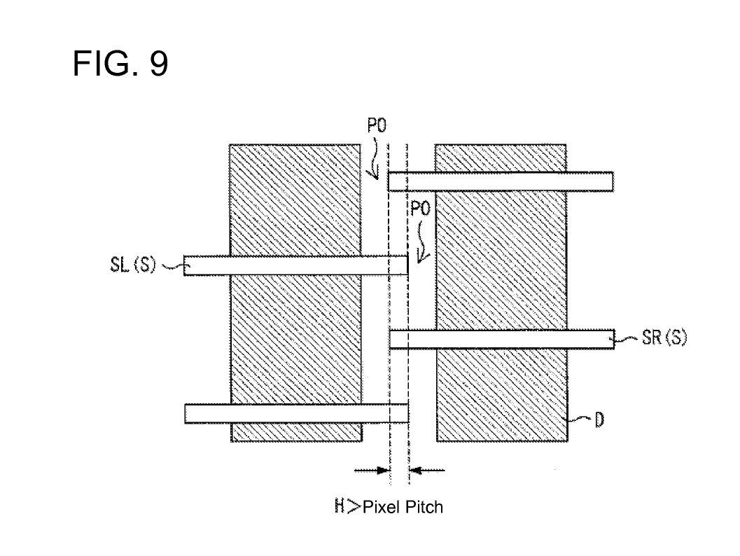

Embodiment 3 of the capacitive touch panel of the present invention will be explained below with reference to FIGS. 8 to 9.

For ease of explanation, the components having the same functions as those in the drawings described in Embodiment 1 above are given the same reference characters, and the descriptions thereof are omitted.

(Electrode Configuration of Touch Panel)

FIG. 8 is a diagram showing an electrode pattern of a touch panel of the present embodiment.

As shown in FIG. 8, in a touch panel 1C of the present embodiment, drive lines D1 to D10 (first electrode groups) made of ten line-shaped electrodes (first electrodes) are disposed in parallel with each other at even intervals along the Y direction.

Sense lines S1L to S14L (first group of second electrodes) made of fourteen line-shaped electrodes (second electrodes) are disposed in parallel with each other at even intervals along the X direction so as to intersect with the drive lines D1 to D5. Sense lines S1R to S14R (second group of second electrodes) made of fourteen line-shaped electrodes (second electrodes) are disposed in parallel with each other at even intervals along the X direction so as to intersect with the drive lines D6 to D10.

The sense lines S1L to S14L and the corresponding sense lines S1R to S14R are offset from each other along the Y direction. However, as shown in FIG. 9, which is an enlarged plan view showing a region near the division points between the sense lines S1L to S14L and the sense lines S1R to S14R, ends of the sense lines S1L to S14L on the positive side along the X axis and ends of the sense lines S1R to S14R on the negative side along the X axis overlap each other in the Y axis direction.

The drive lines D1 to D5 operably coupling with only the sense lines S1L to S14L, and the drive lines D6 to D10 operably coupling with only the sense lines S1R to S14R are driven at the same timing in a line-sequential manner.

In the present embodiment, the drive lines D1 to D5 are sequentially applied with prescribed pulse (voltage) signals P1 to P5 via terminals T15 to T19, and the drive lines D6 to D10 are sequentially applied with prescribed pulse (voltage) signals P5 to P1 via terminals T20 to T24. If the pulse signal P has the same number, then it means that these signals are applied at the same time.

The sense lines S1L to S14L are connected to the detection circuit shown in FIG. 3 via the terminals T1 to T14, and the sense lines S1R to S14R are connected to the detection circuit shown in FIG. 3 via the terminals T25 to T38.

When the finger of the operator touches the touch panel 1C, the touched position is detected by the detection circuit shown in FIG. 3 that detects a change in capacitance between at least one drive line out of the drive lines D1 to D10 and at least one sense line out of the sense lines S1R to S14R and S1L to S14L.

In the touch panel 1C of the present embodiment, the sense lines S1 to S14 in the conventional configuration shown in FIG. 16 are divided into the sense lines S1L to S14L and the sense lines S1R to S14R. As shown in FIG. 9, the sense lines S1L to S14L and the corresponding sense lines S1R to S14R are offset from each other in the Y direction. Ends of the sense lines S1L to S14L on the positive side along the X axis and ends of the sense lines S1R to S14R on the negative side along the X axis overlap each other in the Y axis direction.

Therefore, the dividing points PO of the sense lines S do not coincide with each other between upper and lower lines. The width H of the overlapping portion between the upper and lower sense lines S is larger than the pixel pitch. Therefore, in the display device provided with the touch panel of the present embodiment, on the display screen, the dividing points of the sense lines S do not form a clear line, which makes them less noticeable.

In the present embodiment, prescribed pulse (voltage) signals P1 to P5 are sequentially applied to the drive lines D1 to D5, and prescribed pulse (voltage) signals P5 to P1 are sequentially applied to the drive lines D6 to D10. Therefore, as compared with the case in which prescribed pulse (voltage) signals P1 to P10 are sequentially applied to the respective drive lines D1 to D10, the time required for sensing can be reduced by half.

As a result, the charge transfer frequency N can be increased as in Embodiment 1 above, which allows the output voltage difference ΔVout to be made larger. Therefore, it is possible to accurately determine whether the screen is touched or not.

### Embodiment 4

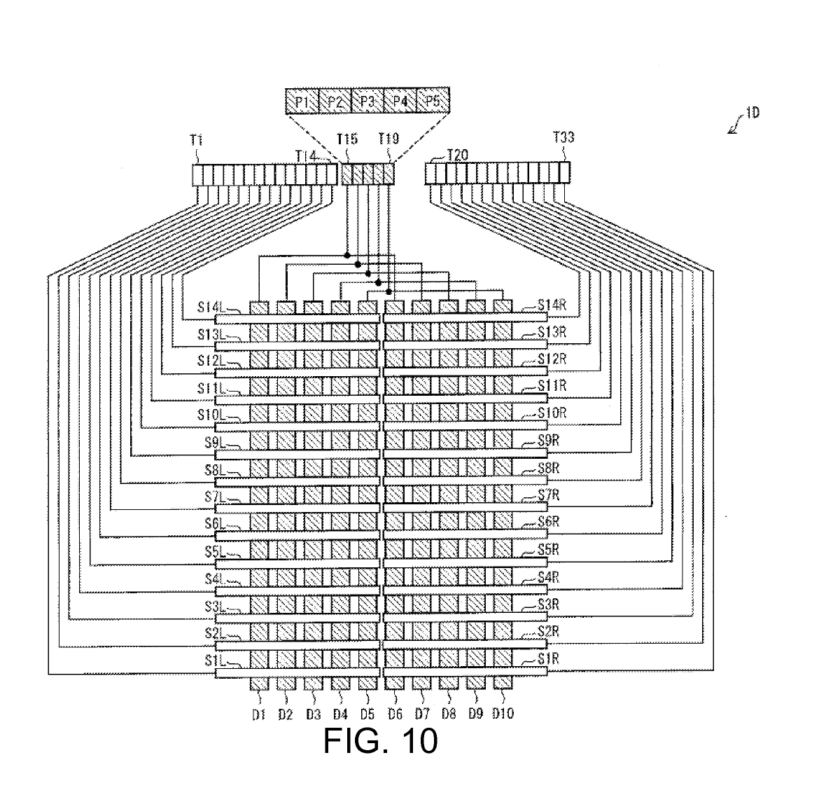

Embodiment 4 of the capacitive touch panel of the present invention will be explained below with reference to FIG. 10.

For ease of explanation, the components having the same functions as those in the drawings described in Embodiment 1 above are given the same reference characters, and the descriptions thereof are omitted.

(Electrode Configuration of Touch Panel)

FIG. 10 is a diagram showing an electrode pattern of a touch panel of the present embodiment.

As shown in FIG. 10, in a touch panel 1D of the present embodiment, the drive lines D1 to D10, the sense lines S1L to S14L, and the sense lines S1R to S14R are patterned in the same manner as the touch panel shown in FIG. 1, and therefore, the description thereof is omitted.

However, as shown in FIG. 10, upon driving, prescribed pulse (voltage) signals P1 to P5 are sequentially applied to the drive lines D1 to D5 via the terminal T15 to T19, and prescribed pulse (voltage) signals P1 to P5 are also sequentially applied to the drive lines D6 to D10 via the terminal T15 to T19.

When a finger of the operator touches the touch panel 1D, the touched position is detected by the detection circuit shown in FIG. 3 that detects at least one of a change in capacitance between at least one drive line out of the drive lines D1 to D5 and at least one sense line out of the sense lines S1L to S14L, and a change in capacitance between at least one drive line out of the drive lines D6 to D10 and at least one sense line out of the sense lines S1R to S14R.

In the touch panel 1D of the present embodiment, the drive lines D1 and D6, the drive lines D2 and D7, the drive lines D3 and D8, the drive lines D4 and D9, and the drive lines D5 and D10 each share a terminal, and therefore, it is possible to reduce the number of terminals.

In the touch panel 1D of the present embodiment, prescribed pulse (voltage) signals P1 to P5 are sequentially applied to the drive lines D1 to D5 and to the drive lines D6 to D10, respectively, via common terminals T15 to T19, and therefore, as compared with the case in which prescribed pulse (voltage) signals P1 to P10 are sequentially applied to the respective drive lines D1 to D10, the time required for sensing can be reduced.

As a result, the charge transfer frequency N can be increased as in Embodiment 1 above, which allows the output voltage difference ΔVout to be made larger. Therefore, it is possible to accurately determine whether the screen is touched or not.

In Embodiments 1 to 4 above, the configuration in which ten drive lines D1 to D10, fourteen sense lines SL1 to SL14, and fourteen sense lines SR1 to SR14 are provided was described as an example, but the present invention is not limited thereto. The number “m” of the drive lines D1 to Dm (m is an integer of 2 or greater) and the number “n” of the sense lines S1 to Sn (n is an integer of 1 or greater) can be appropriately set depending on the application of the touch panel, the size of the touch region, and the like. The length and width of the drive lines D1 to Dm, a gap between drive lines, the length and width of the sense lines S1 to Sn, and a gap between sense lines can be appropriately set depending on the application of the touch panel, the size of the touch region, and the like.

### Embodiment 5

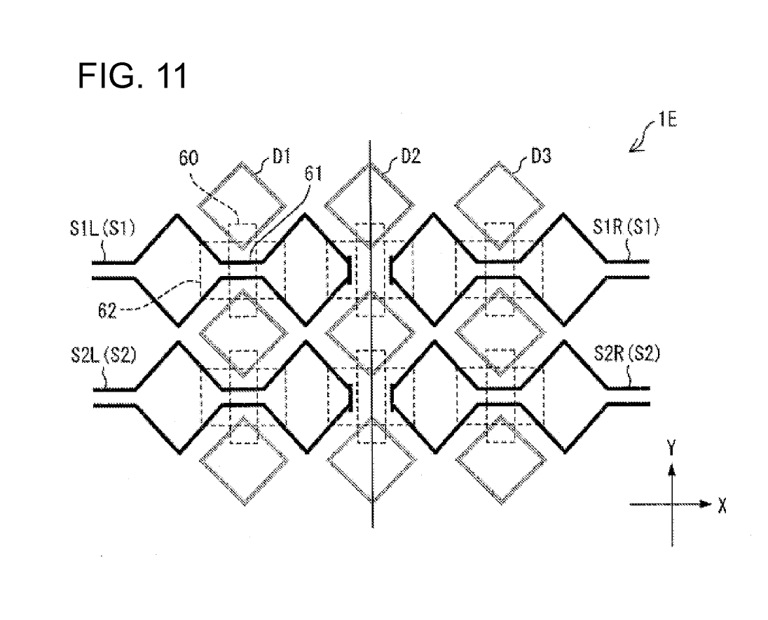

Embodiment 5 of the capacitive touch panel of the present invention will be explained below with reference to FIG. 11.

In each of the touch panels of Embodiments 1 to 4 above, drive lines D1 to Dm made of “m” number (m is an integer of 2 or greater) of line-shaped electrodes, and sense lines S1L to SnL and sense lines S1R to SnR made of “n” number of (n is an integer of 2 or greater) line-shaped electrodes are disposed in different layers so as to be insulated from each other, extending in directions intersecting each other.

In a touch panel of the present embodiment, the drive lines D1 to Dm and the sense lines S1L to SnL and sense lines S1R to SnR are disposed in the same layer, insulated from each other.

(Electrode Configuration of Touch Panel)

Below, with reference to FIG. 11, the touch panel of the present embodiment will be explained. FIG. 11 is a diagram showing an electrode pattern of the touch panel of the present embodiment.

As shown in FIG. 11, a touch panel 1E includes drive lines (first electrode group) D1 to D3 each of which is made of a plurality of diamond-shaped first planar electrodes (first electrodes) that are arranged in a prescribed pattern along the Y direction with a gap therebetween, and sense lines (first group of second electrodes) S1L to S2L and sense lines (second group of second electrode) S1R to S2R each of which is made of a plurality of diamond-shaped second planar electrodes (second electrodes) that are arranged in a prescribed pattern along the X direction with a gap therebetween.

In each of the drive lines D1 to D3, the first planar electrodes arranged along the Y direction are electrically connected to each other via a lower wiring line 60 (first wiring line). In each of the sense lines S1L to S2L and sense lines S1R to S2R, the second planar electrodes arranged along the X direction are electrically connected to each other via an upper wiring line 61 (second wiring line). However, the sense line S1L is separated and insulated from the sense line S1R, and the sense line S2L is separated and insulated from the sense line S2R. An insulating film 62 is disposed between the lower wiring line 60 and the upper wiring line 61, thereby insulating the lower wiring line 60 and the upper wiring line 61 from each other.

In the touch panel 1E of the present embodiment, the sense lines S1 and S2 are respectively divided into the sense lines S1L, S1R and sense lines S2L, S2R. Therefore, the drive line D1 operably coupling with the sense lines S1L, S2L and the drive line D3 operably coupling with the sense lines S1R and S2R can be driven by the same drive signal. This makes it possible to reduce the driving frequency of the drive lines D1 to D3, thereby reducing the sensing time.

Also, in the touch panel 1E of the present embodiment, the drive lines D1 to D3, the sense lines S1L to S2L, and the sense lines S1R to S2R can be disposed in the same layer. This makes it possible to achieve the thickness reduction, and to improve light transmittance.

### Embodiment 6

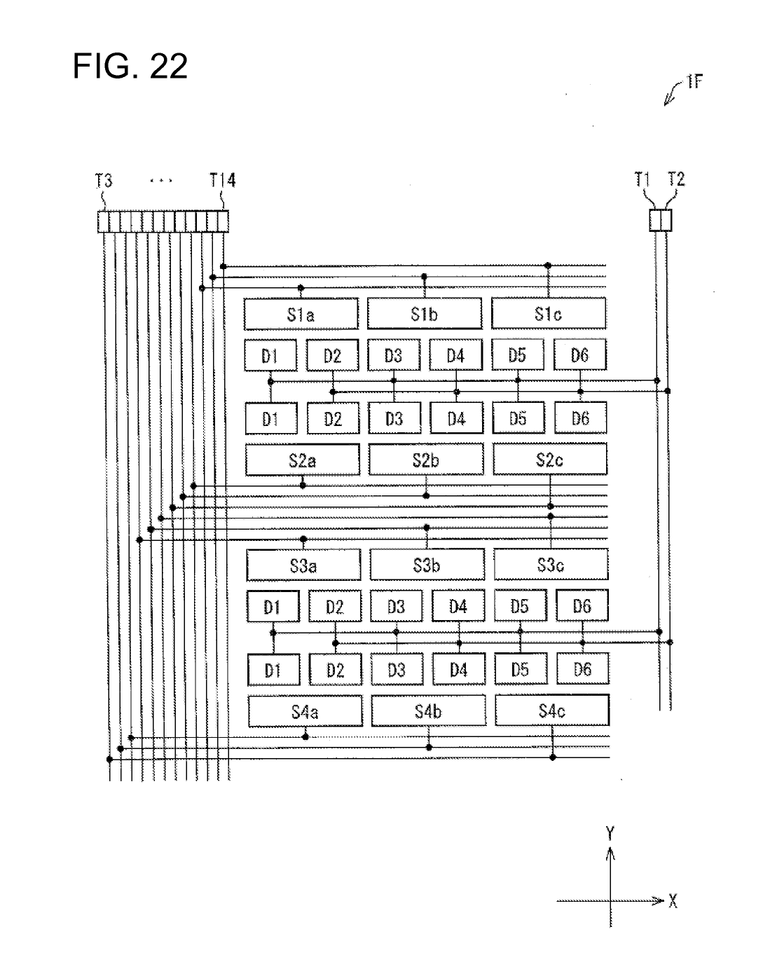

Embodiment 6 of the capacitive touch panel of the present invention will be explained below with reference to FIG. 22.

In each of the touch panels of Embodiments 1 to 5 above, the sense lines S1 to Sn are divided into two groups of the sense lines S1L to SnL and the sense lines S1R to SnR.

In a touch panel of the present embodiment, the sense lines S1 to Sn are divided into three groups of sense lines S1a to Sna (first group of second electrodes), S1b to Snb (second group of second electrodes), and S1c to Snc (third group of second electrodes).

(Electrode Configuration of Touch Panel)

Below, with reference to FIG. 22, the touch panel of the present embodiment will be explained. FIG. 22 is a diagram showing an electrode pattern of the touch panel of the present embodiment.

As shown in FIG. 22, the touch panel 1F includes sense lines S1 to S4 respectively made of a plurality of planar electrodes S1a, S1b, S1c to S4a, S4b, S4c that are arranged in a prescribed pattern along the X direction so as to be separated from each other. Drive lines D1 to D6 are arranged in parallel with the sense lines S1 to S4 and operably couple with the respective sense lines so as to be insulated from the sense lines.

The drive lines D1, D2 in the respective rows operably couple with the sense lines S1a to S4a, respectively; the drive lines D3, D4 in the respective rows operably couple with the sense lines S1b to S4b, respectively; and the drive lines D5, D6 in the respective rows operably couple with the sense lines S1c to S4c, respectively.

The drive lines D1, D2 that operably couple with only the sense lines S1a to S4a, the drive lines D3, D4 that operably couple with only the sense lines S1b to S4b, and the drive lines D5, D6 that operably couple with only the sense lines S1c to S4c are driven in a line-sequential manner at the same timing or at a timing that is set such that respective driving periods overlap each other.

In the present embodiment, prescribed pulse (voltage) signals are sequentially applied to the drive lines D1, D3, D5, and then D2, D4, and D6 via terminals T1 and T2.

The sense lines S1 to S4 are connected to a detection circuit via terminals T3 to T14.

In the touch panel 1F of the present embodiment, the sense lines S1 to S4 are each divided into three groups of the sense lines S1a to S1c, S2a to S2c, S3a to S3c, and S4a to S4c. Therefore, the drive lines D1 to D2 operably coupling with the sense lines S1a to S4a, the drive lines D3 to D4 operably coupling with the sense lines S1b to S4b, and the drive lines D5 to D6 operably coupling with the sense lines S1c to S4c can be driven line-sequentially at the same timing or a timing that is set such that respective driving periods overlap each other.

Therefore, the driving frequency for the drive lines D1 to D6 can be reduced to one third, which is an inverse number of three, i.e., the number of groups, and as a result, the time required for sensing can be reduced to one third.

Also, in the touch panel 1F of the present embodiment, the drive lines D1 to D6 and the sense lines S1a to S4a, S1b to S4b, and S1c to S4c can be disposed in the same layer. This makes it possible to achieve the thickness reduction, and to improve light transmittance.

The touch panels of Embodiments 1 to 6 above can be used for any of the external type touch panel, the in-cell type touch panel, and the on-cell type touch panel.

The present invention is particularly effective for a display device provided with the in-cell type touch panel, for example, in which the sensing operation can only be allowed during the vertical blanking period in order to eliminate effects of noise from the display driver circuit, and the sensing time is therefore limited.

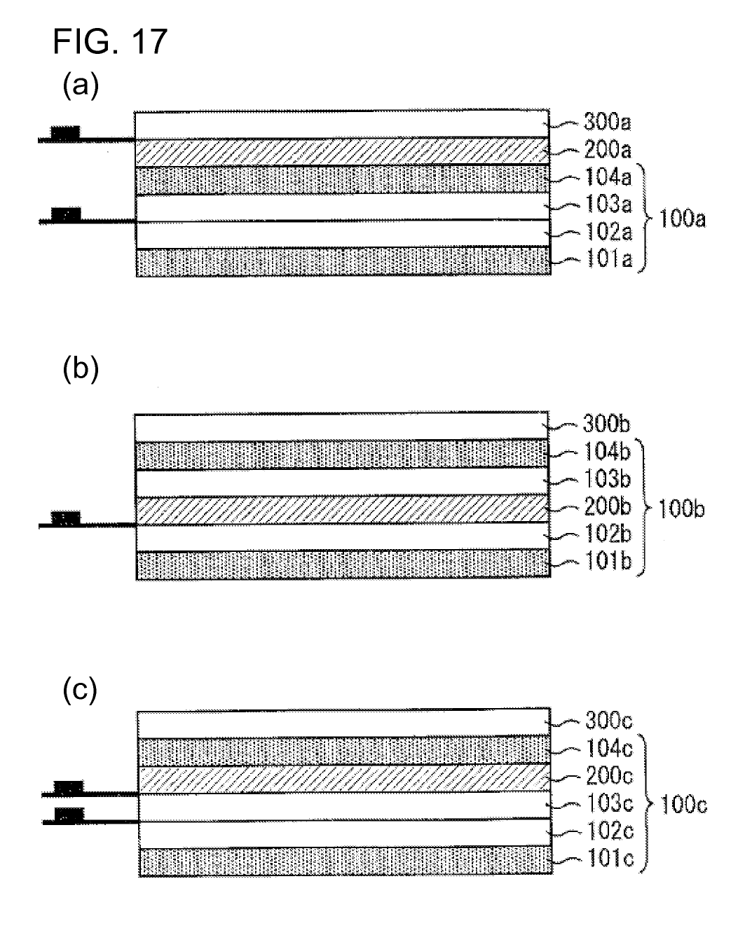

As described above with reference to FIG. 17(a) that illustrates a liquid crystal display device equipped with the external type touch panel 200a, the display panel 100a includes the TFT array substrate 102a, the color filter substrate 103a, and a display element (not shown) disposed therebetween. The front polarizing plate 104a is provided on the front side of the color filter substrate 103a, and the rear polarizing plate 101a is provided on the rear side of the TFT array substrate 102a. The touch panel 200a of an external type is provided on the front polarizing plate 104a, and the protective plate 300a is provided thereon. That is, the drive lines D1 to D10 as the first electrode groups, and the sense lines S1R to S14R and the like as the second electrode groups are disposed on the front polarizing plate 104a.

In the touch panel of the present invention, the electrode pattern is not limited to those described in Embodiments 1 to 5 above.

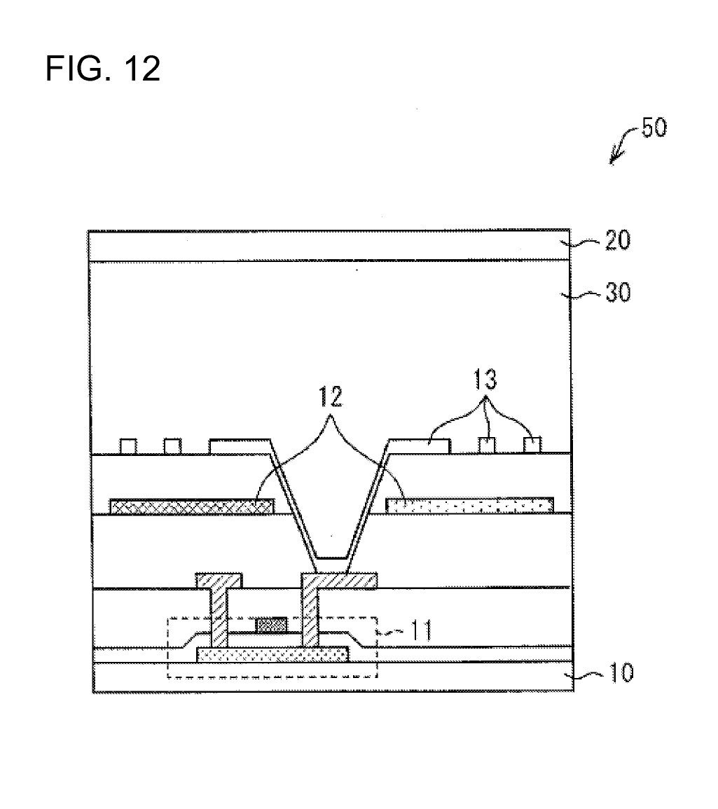

Below, with reference to FIGS. 12 to 15, the electrode pattern of the touch panel will be explained in further detail with specific examples. For ease of explanation, components having the same functions as those described in the embodiments above are given the same reference characters in each example below.

### Example 1

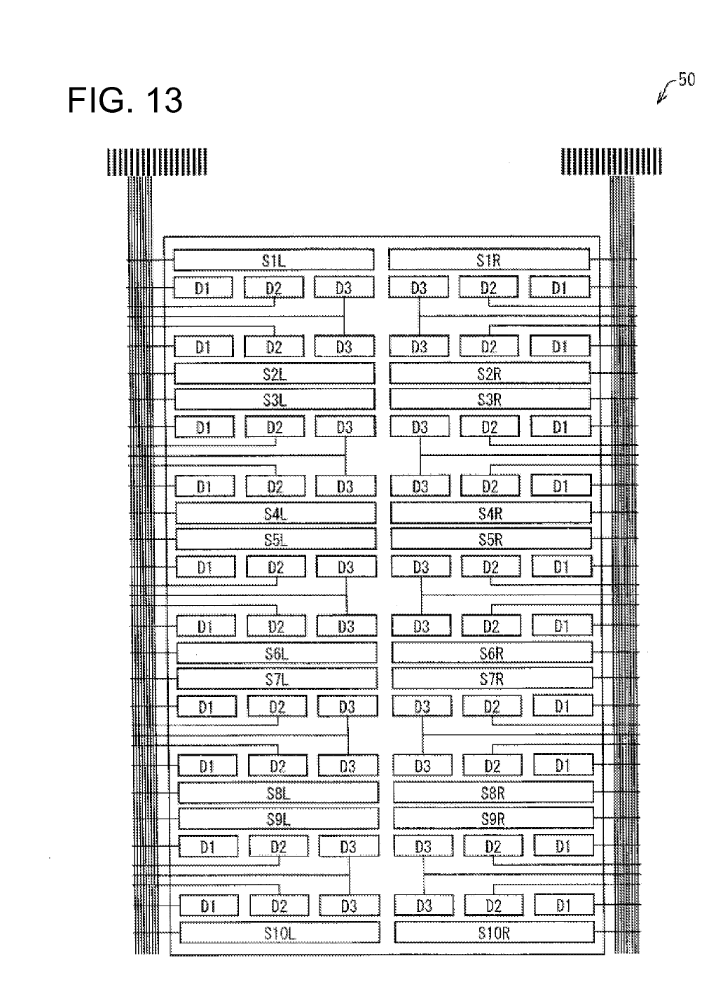

Below, Example 1 will be explained with reference to FIGS. 12 to 13. In the present example, a liquid crystal display device of an IPS mode will be explained as an electronic device. This liquid crystal display device is provided with an in-cell type touch panel.

The IPS mode differs from other operation modes in that liquid crystal molecules rotate parallel to the horizontal plane of the glass substrates. In the IPS mode, the liquid crystal modules are not tilted. Therefore, a change in optical characteristics due to a viewing angle is small, and the wider viewing angle can be achieved.

(Configuration of Liquid Crystal Display Device)

FIG. 12 is a cross-sectional view showing a configuration of a liquid crystal display device according to the present example.

As shown in FIG. 12, a liquid crystal display device 50 includes a TFT array substrate 10, a color filter substrate 20, and a liquid crystal layer 30 disposed therebetween. On the TFT array substrate 10, TFTs (thin film transistors) 11 and pixel electrodes 13 are provided corresponding to respective pixels, and the TFTs 11 and the pixel electrodes 13 are electrically connected to each other via contact holes.

The pixel electrodes 13 are made of a transparent conductive material such as ITO (indium tin oxide), for example. In order to prevent uneven display, and in order to minimize the required voltage, the pixel electrode 13 is formed in a comb shape.

A common electrode 12 is disposed between the TFTs 11 and the pixel electrodes 13. The common electrode 12 is made of a transparent conductive material such as ITO (indium tin oxide), for example. The liquid crystal layer 30 is driven by a voltage applied between the comb-shaped pixel electrode 13 and the common electrode 12 formed in the TFT array substrate 10.

The common electrode 12 is patterned so as to be also used as the sense lines S and the drive lines D. In this manner, the liquid crystal display device 50 having a touch functionality is achieved.

(Electrode Configuration of Touch Panel)

FIG. 13 is a diagram showing a pattern of the common electrode of the liquid crystal display device of the present embodiment.

As shown in FIG. 13, the sense lines S are divided in the center into sense lines S1L to S10L and sense lines S1R to S10R. The drive lines D that respectively couple with different sense lines S can be driven at the same time. Therefore, the drive lines D1 to D3 coupling with the sense line S1L and the drive lines D1 to D3 coupling with the sense line S1R, for example, can be driven at the same time by applying prescribed pulse (voltage) signals P1 to P3 sequentially.

(Line-Sequential Driving)

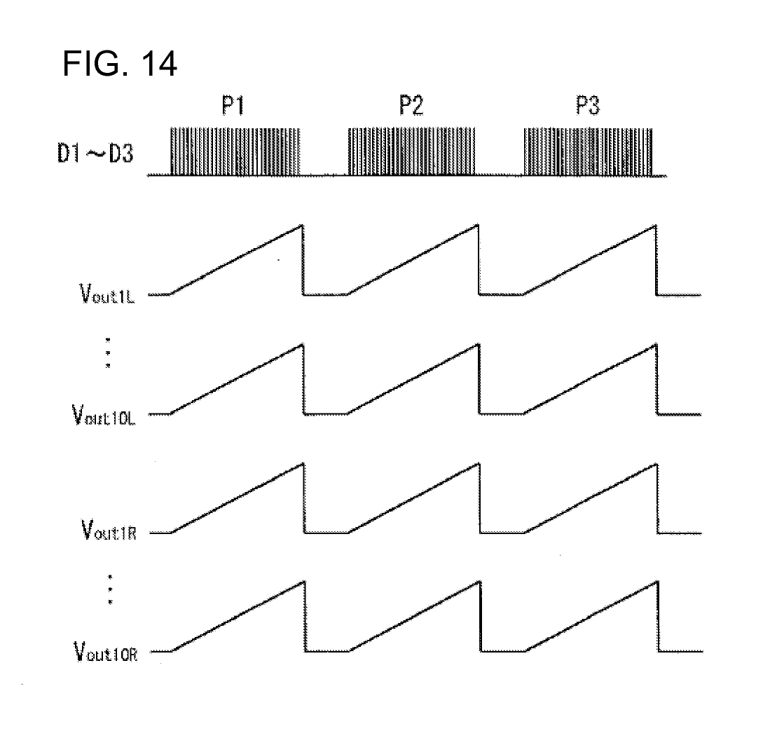

FIG. 14 is a waveform diagram showing voltage signals outputted from the detection circuits connected to the sense lines S1L to S10L and the sense lines S1R to S10R, and voltage signals applied to the drive lines D1 to D3.

As shown in FIG. 14, in the liquid crystal display device 50, upon driving, prescribed pulse (voltage) signals P1 to P3 are respectively applied to the drive lines D1 to D3 operably coupling with the sense lines S1L to S10L and to the drive lines D1 to D3 operably coupling with the sense lines S1R to S10R, and from the sense lines S1L to S10L and the sense lines S1R to S10R, voltages that correspond to charges accumulated in the integral capacitance CINT are outputted as the output Vout by the detection circuit shown in FIG. 3.

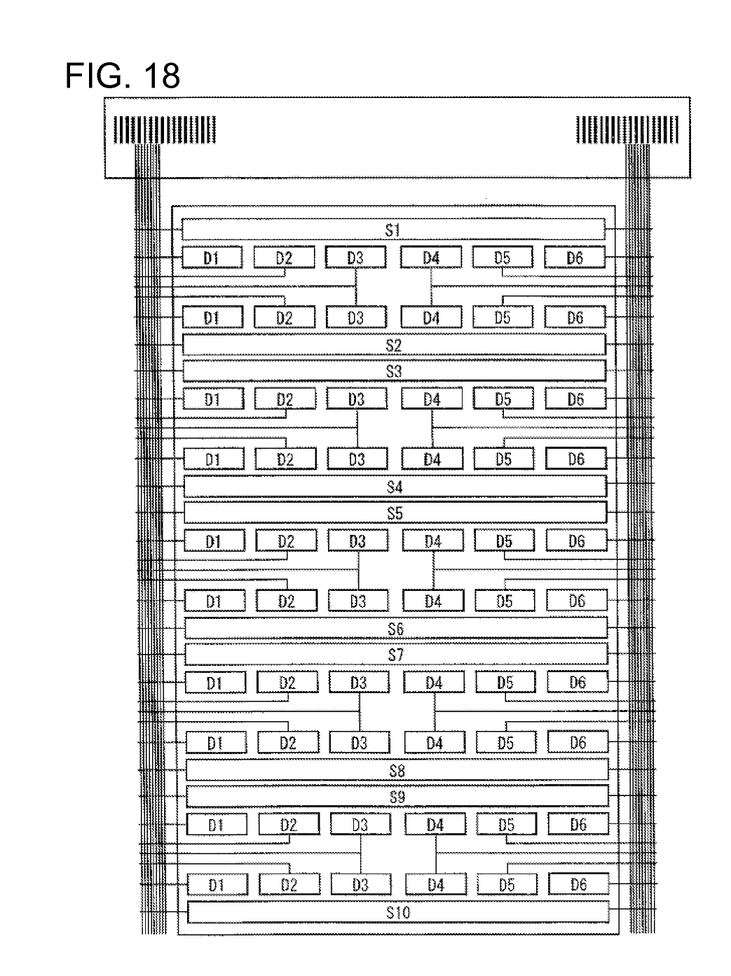

As a result, as compared with the conventional technology shown in FIG. 18 in which prescribed pulse (voltage) signals P1 to P6 are sequentially applied to the drive lines D1 to D6, the driving frequency of the drive lines D is reduced, and the sensing time can be reduced.

When a finger of the operator touches the liquid crystal display device 50, the touched position is detected by the detection circuit shown in FIG. 3 that detects at least one of a change in capacitance between at least one drive line out of the drive lines D1 to D3 and at least one sense line out of the sense lines S1L to S10L, and a change in capacitance between at least one drive line out of the drive lines D4 to D6 and at least one sense line out of the sense lines S1R to S10R.

Because the sensing time can be reduced, the charge transfer frequency N can be increased, and as a result, the output voltage difference ΔVout can be made larger. Therefore, it is possible to accurately determine whether the screen is touched or not.

### Example 2

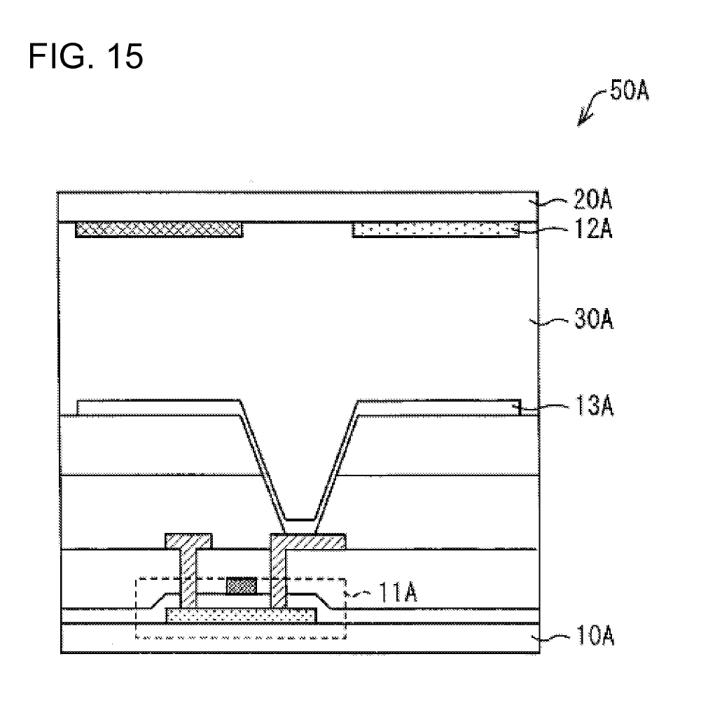

Below, Example 2 will be explained with reference to FIG. 15. In the present example, a liquid crystal display device of a VA mode will be explained as an electronic device. This liquid crystal display device is provided with an in-cell type touch panel.

(Configuration of Liquid Crystal Display Device)

FIG. 15 is a cross-sectional view showing a configuration of a liquid crystal display device according to the present example.

As shown in FIG. 15, a liquid crystal display device 50A includes a TFT array substrate 10A, a color filter substrate 20A, and a liquid crystal layer 30A disposed therebetween. On the TFT array substrate 10A, TFTs (thin film transistors) 11A and pixel electrodes 13A are provided corresponding to respective pixels, and the TFTs 11A and the pixel electrodes 13A are electrically connected to each other via contact holes. The pixel electrodes 13A are made of a transparent conductive material such as ITO (indium tin oxide), for example. On the other hand, the color filter substrate 20A is provided with an opposite electrode 12A. The opposite electrode 12A is made of a transparent conductive material such as ITO (indium tin oxide), for example.

The liquid crystal layer 30A is driven by a voltage applied between the pixel electrodes 13A formed in the TFT array substrate 10A and the opposite electrode 12A formed in the color filter substrate 20A.

The opposite electrode 12A is patterned so as to be also used as the sense lines S and the drive lines D. In this manner, the liquid crystal display device 50A having a touch functionality is achieved.

The opposite electrode 12A is patterned in the same manner as the pattern of the common electrode 12 shown in FIG. 13. A common electrode (not shown) is patterned in the same manner as the opposite electrode 12A, and is electrically connected to the corresponding opposite electrode 12A. This is because the common electrode and the opposite electrode 12A need to operate in the same manner during the sensing operation, and therefore, it is necessary to make the pattern of the common electrode the same as the pattern of the opposite electrode 12A.

The drive lines D that respectively couple with different sense lines S can be driven at the same time, and therefore, it is possible to reduce the driving frequency of the drive lines D, thereby reducing the sensing time. Because the sensing time can be reduced, the charge transfer frequency N can be increased, which allows the output voltage difference ΔVout to be made larger. As a result, it is possible to accurately determine whether the screen is touched or not.

In the present example, a VA mode liquid crystal display device was explained, but the same configuration can be used for an ECB mode liquid crystal display device.

In the descriptions below, the “groups of first electrodes that are driven line-sequentially at the same timing, or at a timing that is set such that respective driving periods overlap each other,” is referred to as the “groups of first electrodes that have overlapping driving periods.”

In order to solve the above-mentioned problems, in the touch panel of an embodiment of the present invention, it is preferable that dividing positions at which conductive paths of the second electrodes are electrically isolated in the second direction coincide with each other.

With this configuration, there is no first electrode group that operably couple with a plurality of the second electrode groups. Therefore, it is possible to drive each first electrode group that operably couples with only one of the plurality of second electrode groups at the same timing, or at a timing that is set such that respective driving periods overlap with each other. As a result, the driving time can be reduced according to the number of the first electrode groups that have overlapping driving periods, which allows the sensing time to be reduced.

Thus, in a touch panel that detects a touched position by utilizing the charge transfer scheme, the frequency of charge transfer can be increased, thereby making it possible to increase a difference in output voltage between when the screen is touched and when the screen in not touched. Thus, it becomes possible to accurately determine whether the screen is touched or not.

Also, it is possible to form the first electrode group and the second electrode group with ease through a simple patterning process.

In order to solve the above-mentioned problems, in the touch panel of an embodiment of the present invention, it is preferable that dividing position at which conductive paths of the second electrodes are electrically isolated in the second direction vary.

With this configuration, because the dividing points in the second direction at which the respective conductive paths of the second electrodes are electrically isolated vary, a line formed by the dividing points becomes less noticeable on the display screen. As long as a plurality of groups of first electrodes each of which has overlapping driving periods can be formed, the dividing points may vary regularly or irregularly.

In order to solve the above-mentioned problems, in the touch panel of an embodiment of the present invention, it is preferable that the first electrodes belonging to each set that operably couples with only one of the plurality of groups of second electrodes be driven line-sequentially at the same timing via the same terminals.

With this configuration, the respective sets of the first electrodes each operably coupling with one of the plurality of second electrode groups are driven via the same terminals, and therefore, the number of terminals can be reduced.

In order to solve the above-mentioned problems, in the touch panel of an embodiment of the present invention, it is preferable that the group of first electrodes be made of a plurality of line-shaped electrodes, that each of the plurality of groups of second electrodes be made of at least one line-shaped electrode, and that the line-shaped electrodes of the groups of second electrodes and the line-shaped electrodes of the group of first electrodes be disposed intersecting with each other while being isolated from each other.

With this configuration, the first electrode groups and the second electrode groups can be formed with ease through patterning.

In order to solve the above-mentioned problems, in the touch panel of an embodiment of the present invention, it is preferable that each of the plurality of first electrodes be made of a plurality of first planar electrodes that are separated from each other, that, in each of the first electrodes, the plurality of first planar electrodes be electrically connected to each other through a first wiring line, that the at least one second electrode be made of a plurality of second planar electrodes that are separated from each other, and that in the second electrode of each of the plurality of groups of second electrodes, the second planar electrodes be electrically connected to each other through a second wiring line.

With this configuration, the first electrode group and the second electrode group can be formed in the same layer through patterning by having the first wiring lines and the second wiring line insulated from each other at respective intersections. As a result, the thickness can be reduced, and the light transmittance can be improved.

In order to solve the above-mentioned problems, a display device of the present invention includes the above-mentioned touch panel.

With this configuration, a display panel provided with a touch panel that can detect an object accurately and quickly can be achieved.

In order to solve the above-mentioned problems, in the display device of an embodiment of the present invention, it is preferable that the first electrodes and the second electrodes be made of a transparent electrode.

With this configuration, in a display device having a touch functionality, an effect on the display can be eliminated.

In order to solve the above-mentioned problems, in the display device of an embodiment of the present invention, it is preferable that an active matrix substrate and an opposite substrate be provided having a liquid crystal layer therebetween, that the liquid crystal layer be driven by a voltage applied between a common electrode and a pixel electrode formed in the active matrix substrate, and that the common electrode be patterned so as to be also used as the first electrode group and the second electrode group.

In a display device provided with the in-cell type touch panel, the sensing can only be allowed during the vertical blanking period so as to eliminate effects of the display, and the sensing time is therefore limited. With this configuration, the sensing time can be reduced. Therefore, in a touch panel that detects a touched position by utilizing the charge transfer scheme, the frequency of charge transfer can be increased, thereby making it possible to increase a difference in output voltage between when the screen is touched and when the screen in not touched. Therefore, in the display device provided with the touch panel, it is possible to accurately determine whether the screen is touched or not.

Also, the common electrode is patterned so as to be also used as the first electrodes and the second electrodes. Therefore, it is possible to achieve the thickness reduction, and to improve the light transmittance.

In order to solve the above-mentioned problems, in the display device of an embodiment of the present invention, it is preferable that an active matrix substrate and an opposite substrate be provided having a liquid crystal layer therebetween, that the liquid crystal layer be driven by a voltage applied between pixel electrodes formed in the active matrix substrate and an opposite electrode formed in the opposite substrate, and that the opposite electrode be patterned so as to be also used as the first electrode group and the second electrode group.

In a display device provided with the in-cell type touch panel, the sensing can only be allowed during the vertical blanking period so as to eliminate effects of the display, and the sensing time is therefore limited. With this configuration, the sensing time can be reduced. Therefore, in a touch panel that detects a touched position by utilizing the charge transfer scheme, the frequency of charge transfer can be increased, thereby making it possible to increase a difference in output voltage between when the screen is touched and when the screen in not touched. Therefore, in the display device provided with the touch panel, it is possible to accurately determine whether the screen is touched or not.

Also, the opposite electrode is patterned so as to be also used as the first electrode group and the second electrode group. Therefore, it is possible to achieve the thickness reduction, and to improve the light transmittance.

In order to solve the above-mentioned problems, in the display device of an embodiment of the present invention, it is preferable that an active matrix substrate and an opposite substrate be provided having a liquid crystal layer therebetween, and that the first electrode group and the second electrode group be formed on a side of the opposite substrate opposite to the side facing the active matrix substrate.

With this configuration, it becomes easier to configure a display device provided with the on-cell type touch panel in which the first electrode group and the second electrode group are formed through patterning on the side of the opposite substrate opposite to the side facing the active matrix substrate.

In order to solve the above-mentioned problems, in the display device of an embodiment of the present invention, it is preferable that an active matrix substrate and an opposite substrate be provided having a liquid crystal layer therebetween, that a polarizing plate be formed on a side of the opposite substrate opposite to the side facing the active matrix substrate, and that the first electrode group and the second electrode group be formed on the polarizing plate.

With this configuration, it becomes easier to configure a display device provided with the external type touch panel in which the first electrode group and the second electrode group are formed through patterning on the polarizing plate.

The present invention is not limited to the embodiments and examples described above, and various modifications can be made without departing from the scope of the claims. Therefore, embodiments obtained by appropriately combining the techniques disclosed in different embodiments are included in the technical scope of the present invention.

### INDUSTRIAL APPLICABILITY

The present invention can be suitably used for a display device having a touch functionality.

### DESCRIPTION OF REFERENCE CHARACTERS

1A touch panel
1B touch panel
1C touch panel
1D touch panel
1E touch panel
1F touch panel
10 10A TFT array substrate (active matrix substrate)
11 11A TFT
12 common electrode
12A opposite electrode
13, 13A pixel electrode
20, 20A color filter substrate (opposite substrate)
30, 30A liquid crystal layer
50, 50A liquid crystal display device
60 lower wiring line (first wiring line)
61 upper wiring line (second wiring line)
62 insulating film
D drive line (first electrode group)
S sense line (second electrode group)
S1L to S14L sense line (first group of second electrodes)
S1R to S14R sense line (second group of second electrodes)
T1 to T38 terminal
PO dividing point (dividing position)
X direction (second direction)
Y direction (first direction)

1. A touch panel, comprising:
first electrodes having respective conductive paths extending along a first direction; and
plural groups of second electrodes, each of the plural groups of second electrodes including at least one second electrode, the second electrode having a conductive path extending along a second direction, each of the plural groups of second electrodes operably capacitively couple with one or more of the first electrodes,
wherein a position touched by an object is detected by sensing a change in capacitance between at least one first electrode of the group of first electrodes and at least one second electrode belonging to at least one of the plural groups of second electrodes,
wherein, among the plural groups of second electrodes, respective conductive paths of second electrodes belonging to different groups are electrically isolated from each other, and
wherein plural sets of the first electrodes are defined such that the first electrodes belonging to each of the sets operably couple with only one group of the plural groups of the second electrodes, the first electrodes in the respective sets operably coupling with different groups of the plural groups of the second electrodes and being driven line-sequentially at the same time, or driven line-sequentially at such a timing that respective driving periods overlap each other.

2. The touch panel according to claim 1, wherein dividing positions at which conductive paths of the second electrodes are electrically isolated in the second direction coincide with each other.

3. The touch panel according to claim 1, wherein dividing positions at which conductive paths of the second electrodes are electrically isolated in the second direction vary.

4. The touch panel according to claim 1, wherein the first electrodes belonging to each set that operably couple with only one of the plural groups of second electrodes are driven line-sequentially at the same time through same terminals.

5. The touch panel according to claim 1, wherein the first electrodes are made of a plurality of line-shaped electrodes,
wherein each of the plural groups of second electrodes is made of at least one line-shaped electrode, and
wherein the line-shaped electrodes of the groups of second electrodes and the line-shaped electrodes of the first electrodes are disposed intersecting with each other while being isolated from each other.

6. The touch panel device according to claim 1, wherein each of the first electrodes is made of a plurality of first planar electrodes that are separated from each other,
wherein, in each of the first electrodes, the plurality of first planar electrodes are electrically connected to each other through a first wiring line,
wherein the at least one second electrode is made of a plurality of second planar electrodes that are separated from each other, and
wherein, in the second electrode of each of the plural groups of second electrodes, the second planar electrodes are electrically connected to each other through a second wiring line.

7. A display device comprising the touch panel according to claim 1.

8. The display device according to claim 7, wherein the first electrodes and the second electrodes are made of a transparent electrode.

9. The display device according to claim 7, comprising an active matrix substrate, an opposite substrate, and a liquid crystal layer interposed therebetween,
wherein the liquid crystal layer is driven by a voltage applied between a common electrode and a pixel electrode formed in the active matrix substrate, and
wherein the common electrode is patterned so as to be also used as the first electrodes and the second electrodes.

10. The display device according to claim 7, comprising an active matrix substrate, an opposite substrate, and a liquid crystal layer interposed therebetween,
wherein the liquid crystal layer is driven by a voltage applied between pixel electrodes formed in the active matrix substrate and an opposite electrode formed in the opposite substrate, and
wherein the opposite electrode is patterned so as to be also used as the first electrodes and the second electrodes.

11. The display device according to claim 7, comprising an active matrix substrate, an opposite substrate, and a liquid crystal layer interposed therebetween,
wherein, on a side of the opposite substrate opposite to the side facing the active matrix substrate, the first electrodes and the second electrodes are formed.

12. The display device according to claim 7, comprising an active matrix substrate, an opposite substrate, and a liquid crystal layer interposed therebetween,
wherein a polarizing plate is formed on a side of the opposite substrate opposite to the side facing the active matrix substrate, and
wherein the first electrodes and the second electrodes are formed on the polarizing plate.
